(19) United States
(12) Patent Application Publication
(10) Pub. No.: US 2012/0133636 A1
(43) Pub. Date: May 31, 2012

(54) LED LIGHTING CIRCUIT AND LIQUID CRYSTAL DISPLAY DEVICE

(75) Inventor: Tatsuya KITA, Osaka (JP)

(73) Assignee: FUNAI ELECTRIC CO., LTD., Osaka (JP)

(21) Appl. No.: 13/300,665

(22) Filed: Nov. 21, 2011

(30) Foreign Application Priority Data
Nov. 29, 2010 (JP) 2010-264917

(51) Int. Cl. G06F 3/038; H05B 37/02

(52) U.S. Cl. 345/212; 315/224; 315/127

(57) ABSTRACT

The present invention discloses an LED lighting circuit that generates a power supply voltage required to light an LED by boosting a power supply voltage. The LED lighting circuit includes a power supply circuit that is formed integrally with the LED lighting circuit and supplies the power supply voltage. The LED lighting circuit further includes a feedback circuit that detects an LED current flowing to the LED and feeds the LED current back to the power supply circuit. The power supply circuit controls the power supply voltage supplied to the LED lighting circuit so that the LED current converges on a target value.

### CROSS-REFERENCES TO RELATED APPLICATIONS

The present application is related to the Japanese Patent Application No. 2010-264917, filed Nov. 29, 2010, the entire disclosure of which is expressly incorporated by reference herein.

### BACKGROUND OF THE INVENTION

1. Field of the Invention

The present invention relates to a light emitting diode (LED) lighting circuit that generates a power supply voltage required to light an LED by boosting a power supply voltage, and a liquid crystal display device that uses the LED lighting circuit as a light source of a liquid crystal panel.

2. Description of the Related Art

A conventional LED lighting circuit generates a power supply voltage required to light an LED by boosting a power supply voltage supplied from a switching power supply circuit through control performed by a dedicated driver IC (Integrated Circuit).

Japanese Patent Application Publication No. 2010-40209, Japanese Patent Application Publication No. 2008-118089, Japanese Patent Application Publication No. 2008-186668, and Japanese Patent Application Publication No. 2009-238633 disclose techniques relating to the lighting of a fluorescent tube, an LED, and so on.

When an LED drive circuit is configured using a dedicated IC, however, a circuit configuration becomes complicated, leading to an increase in cost.

### BRIEF SUMMARY OF THE INVENTION

The present invention discloses an LED lighting circuit to simplify a circuit configuration of an LED lighting circuit, thereby reducing a cost of the LED lighting circuit.

One aspect of the present invention provides an LED lighting circuit that generates a power supply voltage required to light a light emitting diode (LED) by boosting a power supply voltage, comprising:
a power supply circuit that is formed integrally with the LED lighting circuit and supplies the power supply voltage; and
a feedback circuit that detects an LED current flowing to the LED and feeds the LED current back to the power supply circuit, and
the power supply circuit controls the power supply voltage supplied to the LED lighting circuit so that the LED current converges on a target value.

These and other features, aspects, and advantages of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” is used exclusively to mean “serving as an example, instance, or illustration.” Any embodiment described as “exemplary” is not necessarily to be construed as preferred or advantageous over other embodiments.

FIG. 1 is an exemplary illustration of a block diagram showing a schematic electric configuration of a liquid crystal display device;

FIG. 2 is a circuit diagram showing an example of an LED lighting circuit formed integrally with a power supply circuit; and

FIG. 3 is a circuit diagram showing a comparative example of an LED lighting circuit and a power supply circuit.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

An embodiment of the present invention will be described below. It goes without saying that the below-described embodiment merely exemplifies the present invention.

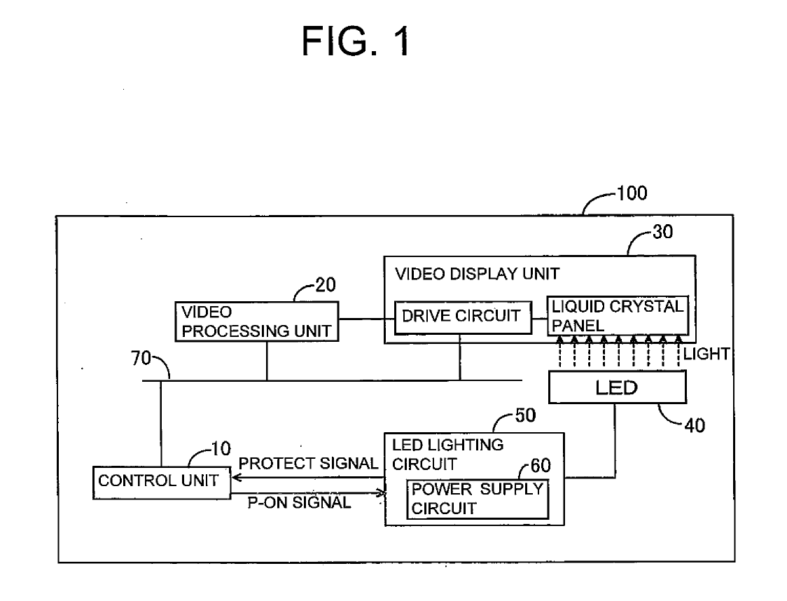

An embodiment of the present invention will be described below with reference to FIGS. 1 to 3.

### First Aspect

An LED lighting circuit 50 that generates a power supply voltage required to light an LED 40 by boosting a power supply voltage includes:
a power supply circuit 60 that is formed integrally with the LED lighting circuit 50 and supplies the power supply voltage; and
a feedback circuit 54 that detects an LED current flowing to the LED 40 and feeds the LED current back to the power supply circuit 60,
wherein the power supply circuit 60 controls the power supply voltage supplied to the LED lighting circuit 50 so that the LED current converges on a target value.

### Second Aspect

Further, the present invention is an LED lighting circuit that generates a power supply voltage required to light an LED by boosting a power supply voltage supplied from a power supply circuit through control performed by a driver IC,
wherein the driver IC is erased and the power supply circuit is integrated with the LED lighting circuit,
a feedback circuit 54 is provided to detect an LED current flowing to the LED and feed the LED current back to the power supply circuit, and
the power supply circuit has a side face that controls the power supply voltage supplied to the LED lighting circuit so that the LED current converges with a target value.

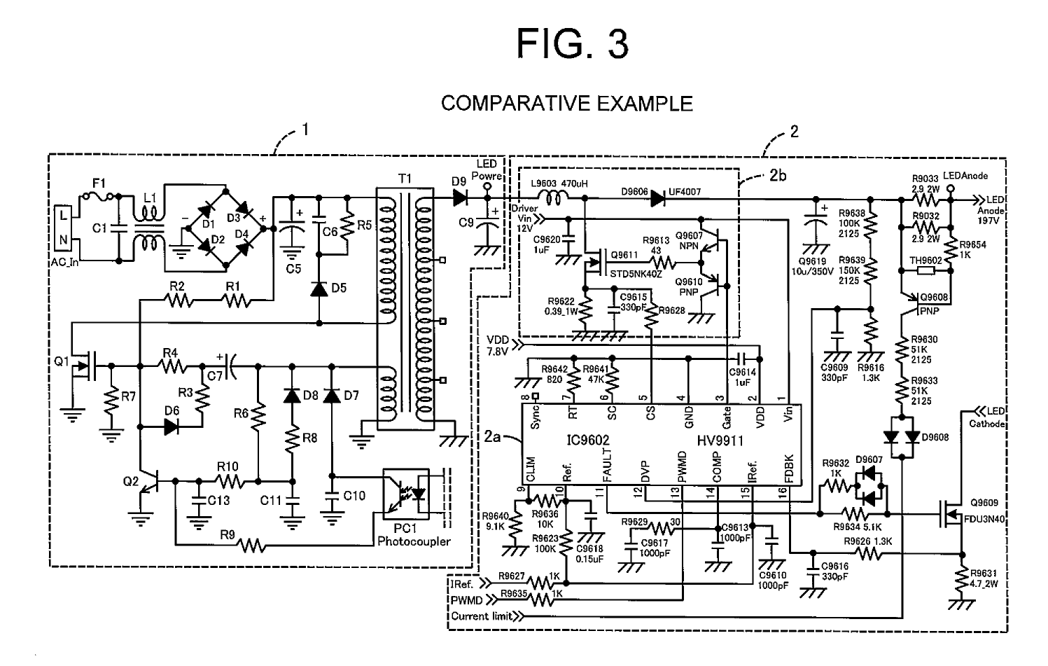

FIG. 3 is a circuit diagram showing a comparative example of an LED lighting circuit used as a backlight of a liquid crystal display device and a power supply circuit for supplying a power supply voltage to the LED lighting circuit. As shown in the drawing, a power supply circuit 1 is constituted by a self-excited switching power supply circuit that outputs a power supply voltage to an LED lighting circuit 2 and performs feedback control using power supply voltages outputted to circuits other than the LED lighting circuit 2.

In FIG. 3, the LED lighting circuit 2 includes a driver IC 2a that controls power supplied to the LED from the power supply circuit 1, and a boosting circuit 2b that boosts the LED power supplied from the power supply circuit 1 in accordance with control performed by the driver IC 2a. The driver IC 2a also has a function for detecting an overvoltage or an overcurrent in the power supplied to the LED and either suppressing or halting an output.

The LED lighting circuit 2 configured as shown in FIG. 3 operates as follows. First, the driver IC 2a inputs a VDD (7.8 V) from a VDD terminal, and outputs a 0 to 7.8 V pulse signal generated by internally regulating a Vin (12 V) input into a Vin terminal from a Gate terminal The Vin (12 V) serves as a driving voltage of the driver IC, while the VDD (7.8 V) serves as a reference voltage of the pulse signal output from the gate terminal. The driver IC 2a drives transistors Q9607, Q9610 using a PWM (Pulse Width Modulation) signal, and finally ON-OFF controls a FET (Field Effect Transistor) Q9611. As a result of this ON-OFF control, the FET Q9611, a coil L9603, and a Schottky diode D9606 boost the LED power input from the power supply circuit 1 to an appropriate voltage, thereby generating/outputting a voltage (197 V in the drawing) to be applied to an anode of the LED. The transistors Q9607, Q9610, the FET Q9611, the coil L9603, the Schottky diode D9606, and so on constitute the boosting circuit 2b.

The LED is constituted by an LED bar formed by connecting LEDs in series, for example, and functions as a light source (a backlight) for emitting light from a back surface of a liquid crystal panel. A cathode of the LED is connected to a source terminal of the FET Q9609. A base terminal of the FET Q9609 is connected to a FAULT terminal of the driver IC 2a so as to be turned ON normally by an output voltage from the FAULT terminal. In other words, a source-drain of the FET Q9609 is normally conductive. However, when an abnormality such as an overcurrent or an overvoltage is detected by the driver IC 2a, the output voltage from the FAULT terminal is stopped such that the FET Q9609 turns OFF. As a result, the power supplied to the LED is halted.

Here, a voltage (to be referred to hereafter as a resistor voltage) generated in a resistor R9631 by a current (identical to the current flowing to the LED) flowing to the resistor R9631 is input into an FDBK terminal. Further, a reference voltage used in a comparison with the voltage of the FDBK terminal of the driver IC 2a is input into an Iref terminal of the driver IC 2a. The driver IC 2a compares the reference voltage of the Iref terminal with the resistor voltage of the FDBK terminal, and controls the boosting circuit 2b so that the reference voltage and the resistor voltage match. More specifically, when the reference voltage is smaller than the resistor voltage, control is performed to increase the output of the boosting circuit 2b by adjusting the PWM signal output from the Gate terminal, and when the reference voltage is larger than the resistor voltage, control is performed to reduce the output of the boosting circuit 2b by adjusting the PWM signal output from the Gate terminal.

In the LED lighting circuit according to the comparative example, an LED drive circuit is configured using a dedicated IC, and therefore the circuit configuration becomes complicated, leading to an increase in cost.

According to the LED lighting circuit 50 described above, on the other hand, the feedback circuit 54 feeds a feedback signal corresponding to the current value flowing to the LED 40 back to the power supply circuit 60, and on the basis of the feedback signal, the power supply circuit 60 controls the power supply voltage supplied to the LED lighting circuit 50 so that the LED current converges on the target value. Hence, a voltage at which the current value flowing to the LED 40 converges on the target value can be supplied to the LED 40, and as a result, the LED 40 can be lit with stability. In other words, the output of the power supply circuit 60 can be optimized for lighting the LED 40, and therefore the need to prepare a separate driver IC to boost the power supply voltage supplied by the power supply circuit 60 is eliminated. As a result, the driver IC can be erased, leading to simplification of the circuit configuration and a corresponding reduction in cost.

In other words, according to the aspects described above, the driver IC can be erased, and therefore the circuit configuration of the LED lighting circuit 50 can be simplified, leading to a reduction in cost.

### Third Aspect

In a selective aspect of the present invention, the power supply circuit 60 is a switching power supply circuit, the feedback circuit 54 feeds the LED current back to a primary side of the switching power supply circuit 60, and the power supply circuit 60 includes a switch circuit 61 that controls a period in which the power supply voltage is applied to a primary winding of a switching transformer TR1 of the switching power supply circuit 60 so that the LED current converges on the target value.

According to this configuration, the feedback circuit 54 feeds a feedback signal corresponding to the current value flowing to the LED 40 back to the switch circuit 61, and on the basis of the feedback signal, the switch circuit 61 controls the period in which the power supply voltage is applied to the primary winding of the switching transformer TR1. At this time, the switch circuit 61 performs control so that the LED current converges on the target value. Hence, a voltage at which the current value flowing to the LED 40 converges on the target value can be supplied to the LED 40, and as a result, the LED 40 can be lit with stability. In other words, the output of the switching power supply circuit 60 can be optimized for lighting the LED 40, and therefore the need to prepare a separate driver IC to boost the power supply voltage supplied by the switching power supply circuit 60 is eliminated. As a result, the driver IC can be erased, leading to simplification of the circuit configuration and a corresponding reduction in cost.

### Fourth Aspect

In a selective aspect of the present invention, the feedback circuit 54 includes a shunt regulator IC1432 and generates a feedback signal when the shunt regulator IC1432 turns ON such that a current flows from a cathode to an anode of the shunt regulator IC1432. When the LED current is smaller than the target value, the shunt regulator IC1432 turns OFF such that the feedback signal is not input into the switch circuit 61, and when the feedback signal is not input, the switch circuit 61 applies the power supply voltage to the switching transformer TR1 in a predetermined period. When the LED current is larger than the target value, the shunt regulator IC1432 turns ON such that the feedback signal is input into the switch circuit 61, and when the feedback signal is input, the switch circuit 61 reduces the period of the power supply voltage applied to the switching transformer TR1 below the predetermined period.

According to this constitution, the feedback signal fed back to the switch circuit 61 from the feedback circuit 54 is generated when the shunt regulator IC1432 turns ON such that a current flows from the cathode to the anode of the shunt regulator IC1432. In other words, when the LED current is smaller than the target value, the shunt regulator IC1432 turns OFF, and when the LED current is larger than the target value, the shunt regulator IC1432 turns ON. As a result, the switch circuit 61 that determines a switching period on the basis of the feedback signal fed back from the feedback circuit 54 applies the power supply voltage to the switching transformer TR1 in the predetermined period when the feedback signal is not input, and reduces the period of the power supply voltage applied to the switching transformer TR1 below the predetermined period when the feedback signal is input. By configuring the feedback circuit 54 using the shunt regulator IC1432 in this manner, the feedback circuit 54 can be realized with a simple circuit configuration, enabling further circuit simplification and a further reduction in cost.

### Fifth Aspect

In a selective aspect of the present invention, the feedback circuit 54 includes a resistor R24 disposed between a cathode of the LED 40 and the ground, the LED current flows to the resistor R24, and a voltage generated in the resistor R24 is input into a reference terminal of the shunt regulator IC1432. The shunt regulator IC1432 turns OFF if the voltage generated in the resistor R24 is smaller than a voltage generated in the resistor R24 when the LED current is at the target value, and the shunt regulator IC1432 turns ON if the voltage generated in the resistor R24 is larger than the voltage generated in the resistor R24 when the LED current is at the target value.

According to this configuration, a voltage corresponding to the LED current is generated in the resistor R24, and this voltage is input into the reference terminal of the shunt regulator IC1432. Note that the shunt regulator IC1432 is selected such that a voltage that corresponds to the voltage generated in the resistor R24 when the LED current is at the target value serves as a reference voltage. Hence, the shunt regulator IC1432 turns OFF if the voltage generated in the resistor R24 is smaller than the voltage generated in the resistor R24 when the LED current is at the target value, and turns ON if the voltage generated in the resistor R24 is larger than the voltage generated in the resistor R24 when the LED current is at the target value. As a result, the feedback circuit 54 can be realized by a simple circuit configuration using the current detecting resistor R24, enabling further circuit simplification and a further reduction in cost.

### Sixth Aspect

In a selective aspect of the present invention,
the switching power supply circuit 60 is a self-excited switching power supply circuit,
the feedback circuit 54 feeds the LED current back to a primary side of the switching power supply circuit 60,
the power supply circuit 60 includes a switch circuit 61 that controls a period in which the power supply voltage is applied to a primary winding of a switching transformer TR1 of the switching power supply circuit so that the LED current converges on a target value,
the feedback circuit 54 includes a shunt regulator IC1432, a resistor R24 disposed between a cathode of the LED 40 and the ground, and a photocoupler PC1, such that when an LED 40 side terminal voltage of the resistor R24 is input into a reference terminal of the shunt regulator IC1432 and a current flows from a cathode to an anode of the shunt regulator IC1432, a light emitting element of the photocoupler PC1 is lit such that a current flows to a light receiving element of the photocoupler PC1,
if the voltage generated in the resistor R24 is smaller than a voltage generated in the resistor R24 when the LED current is at the target value, the shunt regulator IC1432 turns OFF such that a current does not flow to the light receiving element of the photocoupler PC1, and when a current does not flow to the light receiving element of the photocoupler PC1, the switch circuit 61 applies the power supply voltage to the switching transformer TR1 in a predetermined period, and
if the voltage generated in the resistor R24 is larger than the voltage generated in the resistor R24 when the LED current is at the target value, the shunt regulator IC1432 turns ON such that a current flows to the light receiving element of the photocoupler PC1, and when a current flows to the light receiving element of the photocoupler PC1, the switch circuit 61 reduces a period in which the power supply voltage is applied to the switching transformer TR1 below the predetermined period.

In other words, the sixth aspect exhibits similar actions to the first to fifth aspects.

### Seventh Aspect

A liquid crystal display device 100 that uses the LED lighting circuit 50 described above as a light source of a liquid crystal panel is also a selective aspect of the present invention.

In other words, the seventh aspect exhibits similar actions to the first to fifth aspects.

(1) Configuration of Liquid Crystal Display Device

FIG. 1 is a block diagram showing a configuration of a liquid crystal television device. A liquid crystal display device 100 shown in the drawing constitutes the liquid crystal display device according to this embodiment.

FIG. 1 is a block diagram showing a schematic electric configuration of the liquid crystal display device. In the drawing, the liquid crystal display device 100 includes a control unit 10 that controls the entire liquid crystal display device 100, a video processing unit 20 that performs various types of video processing on a video signal input into the liquid crystal display device 100, a video display unit 30 that displays a video based on the video signal on a screen, an LED 40 that serves as a light source of the video display unit 30, an LED lighting circuit 50 that generates a power supply voltage for lighting the LED 40, and a power supply circuit 60 that generates various power supply voltages from a power supply voltage input from an external alternating current power supply or the like and supplies the generated power supply voltages to respective parts of the liquid crystal display device 100. The respective configurations 10 to 30 are connected to each other communicably via a bus 70 (for example, an I2C bus or the like), for example.

The control unit 10 may be constituted by a CPU that serves as a calculation processing center, a ROM in which a control program is recorded, and a RAM used as a work area in which to expand the program and record data temporarily, for example. The control unit 10 thus configured controls the liquid crystal display device 100 by having the CPU expand the control program stored in the ROM to the RAM and execute the expanded control program. Needless to say, the control unit 10 may also be realized in the form of a circuit, for example an integrated circuit such as an ASIC (Application Specific Integrated Circuit).

The video processing unit 20 outputs the video signal subjected to various types of video processing to the video display unit 30. Various types of video signals may be input into the video processing unit 20, for example a video signal extracted from a television broadcast signal, a video signal created on the basis of data read from a recording medium such as a DVD (Digital Versatile Disk) or an HD (Hard Disk), and so on. Devices such as a tuner required to receive the television broadcast signal and a reading device (a DVD drive, an HD drive, or the like) required to read data from the recording medium may be built into the liquid crystal display device 100 or attached thereto externally.

The video display unit 30 is constituted by a liquid crystal panel and a drive circuit for the liquid crystal panel. The video display unit 30 thus configured displays a video on a screen of the liquid crystal panel by having the drive circuit drive liquid crystal in the liquid crystal panel on the basis of the video signal input from the video processing unit 20. At this time, the LED 40 emits light from a back surface of the liquid crystal panel in the case of a backlight system, and emits light from a side face of the liquid crystal panel in the case of a side light system.

The LED 40 is constituted by an LED bar formed by connecting a plurality of LEDs in series, for example. The number of LED bars and the number of LEDs connected in series are determined appropriately in accordance with an illumination surface area of the liquid crystal panel.

The LED lighting circuit 50 is formed integrally with the power supply circuit 60, and generates a power supply voltage for lighting the LED 40 on the basis of a power supply voltage supplied from the power supply circuit 60. Note that although the power supply circuit 60 is formed integrally with the LED lighting circuit 50, the power supply circuit 60 may of course supply power supply voltages to parts other than the LED lighting circuit 50. The configuration and actions of the LED lighting circuit 50 integrated with the power supply circuit 60 in this manner will be described in detail below.

(2) Configuration of LED Lighting Circuit

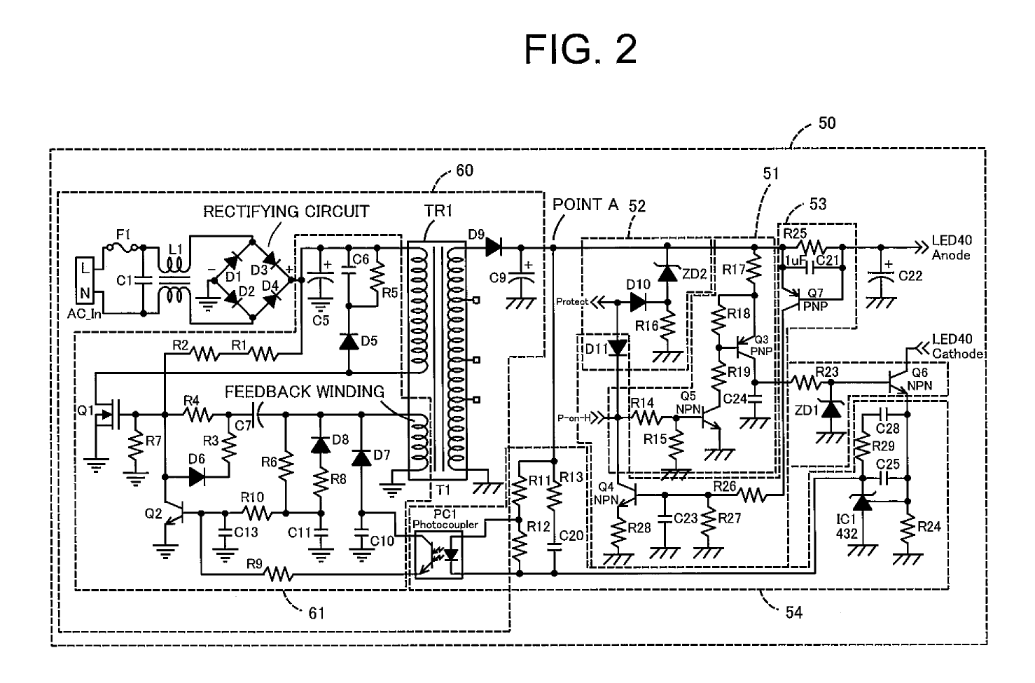

FIG. 2 is a circuit diagram showing an example of the LED lighting circuit formed integrally with the power supply circuit. In the drawing, a configuration of a self-excited oscillation type switching power supply circuit is shown as the power supply circuit 60. However, various types of circuits, including a separately excited oscillation type switching power supply circuit using a driver IC or even a non-switching power supply circuit, may be employed as the power supply circuit 60 as long as an output thereof can be varied on the basis of a feedback signal.

In FIG. 2, the power supply circuit 60 inputs a direct current generated by rectifying and smoothing an alternating current input from the outside using a rectifying circuit and a smoothing circuit into a primary winding of a switching transformer. An application timing of the direct current applied to the switching transformer can be controlled by a switch circuit 61. In other words, the switch circuit 61 is capable of switching application of the power supply voltage to the switching transformer ON and OFF periodically. A plurality of output elements (connection destinations other than an output terminal to the LED lighting circuit 50 are not shown) are provided on a secondary side of the switching transformer, and each output terminal is configured to output a different power supply voltage.

In addition to the power supply circuit 60, the LED lighting circuit 50 includes a start circuit 51 for switching the power supply to the LED 40 ON and OFF in accordance with control executed by the control unit 10, a reduced voltage detection circuit 52 for detecting an abnormal reduction in the voltage supplied to the LED lighting circuit 50 from the power supply circuit 60 and notifying the control unit 10 thereof, an overcurrent detection circuit 53 for detecting an abnormal increase in a current supplied to the LED lighting circuit 50 from the power supply circuit 60 and notifying the control unit 10 thereof, and a feedback circuit 54 that applies feedback to the switch circuit 61 so that a current (to be referred to hereafter as an LED current) flowing through the LED 40 converges on a fixed value (a target value). After receiving feedback from the feedback circuit 54, the switch circuit 61 controls a period in which the power supply voltage is applied to the primary winding of the switching transformer of the power supply circuit 60 so that the LED current converges on the target value.

The respective circuits constituting the LED lighting circuit 50 will now be described more specifically.

The start circuit 51 includes resistors R14, R15, R17, R18, R19, R23, transistors Q5, Q3, Q6, and a capacitor C24.

With this configuration, when a P-ON signal input into the start circuit 51 from the control unit 10 reaches a high level (P-ON-H), the transistors Q5, Q3, Q6 turn ON in sequence, whereby a cathode of the LED 40 is connected to the ground via the resistor R24. In other words, a current flows from an anode to the cathode of the LED 40. When the P-ON signal input from the control unit 10 reaches a low level (P-ON-L), on the other hand, the transistors Q5, Q3, Q6 turn OFF, whereby the current stops flowing to the LED 40.

Hence, by providing the start circuit 51, conduction by the LED 40, or in other words light emission by the LED 40, can be controlled in accordance with a control signal input from the control unit 10, making it possible to switch between display and non-display of a video on the video display unit 30. As a result, a lighting timing of the light source can be controlled appropriately, i.e. without activating a backlight immediately after the liquid crystal display device 100 is activated, by activating the backlight once the power supply and other circuits have stabilized thereafter, and so on.

The reduced voltage detection circuit 52 includes a Zener diode ZD2, a diode D10, and a resistor R16.

With this configuration, when the power supply voltage (a voltage at a point A in FIG. 2) supplied from the power supply circuit 60 is equal to or greater than a predetermined voltage (a Zener voltage of the Zener diode ZD2), the Zener diode ZD2 breaks down such that the voltage at the point A is applied to the resistor R16. The voltage at the point A is higher than a voltage of a protect terminal of the control unit 10. Note that the protect terminal of the control unit 10 is connected, via a resistor, to a constant voltage line (3.3 V or the like, for example) that is lower than the voltage at the point A, for example. When the power supply voltage (the voltage at the point A in FIG. 2) supplied from the power supply circuit 60 is smaller than the predetermined voltage (the Zener voltage of the Zener diode ZD2), on the other hand, the Zener diode ZD2 does not break down, and therefore a current flows to the ground from the constant voltage line through the resistor, the diode D10, and the resistor R16.

Hence, when the Zener diode ZD2 breaks down, the voltage (high level) at the point A is input into the protect terminal of the control unit 10, and when the Zener diode does not break down, a lower voltage (low level) than the constant voltage is input into the protect terminal of the control unit 10. This low level voltage corresponds to a protect signal input into the control circuit 10. The control unit 10 can detect a reduced voltage in the LED lighting circuit 50 and perform protect processing by monitoring the voltage level of the protect terminal.

The overcurrent detection circuit 53 includes resistors R25, R26, R27, R28, capacitors C21, C23, transistors Q4, Q7, and a diode D11.

With this configuration, when a voltage generated in the resistor R25 by a current flowing to the resistor R25 exceeds an ON voltage of the transistor Q7, the transistor Q7 turns ON, whereby the current is released to the ground via the resistor R27. At the same time, the transistor Q4 also turns ON such that the P-ON-H signal input into the LED lighting circuit 50 from the control unit 10 is drawn into the ground. As a result, current output to the LED 40 is stopped. Further, the protect terminal of the control unit 10 is drawn into the ground (the low level) via the diode D11. This low level voltage corresponds to the protect signal input into the control unit 10.

The control unit 10 can detect a reduced voltage in the LED lighting circuit 50 and perform protect processing by monitoring the voltage level of the protect terminal.

The protect processing may take various forms as long as the liquid crystal display device 100 and the LED lighting circuit 50 can be protected thereby. For example, processing such as monitoring the protect terminal periodically and modifying the P-ON signal to the low level when a reduced voltage or an overcurrent is detected a predetermined number of times consecutively within a predetermined time may be performed. Needless to say, oscillation by the power supply circuit 60 may itself be stopped by separately providing a circuit for stopping oscillation by the power supply circuit 60.

The feedback circuit 54 includes a shunt regulator IC1432, resistors R11, R12, R13, R24, R29, capacitors C20, C25, C28, and a photocoupler PC1.

With this configuration, the LED current flows to the resistor R24, an LED 40 side terminal voltage of the resistor R24 is input into a reference terminal of the shunt regulator IC1432, and a voltage generated in the resistor R24 when the LED current flowing to the resistor R24 is at the target value is set in the shunt regulator IC1432 as a reference voltage. Therefore, when the LED current flowing to the resistor R24 decreases below the target value, the shunt regulator IC1432 turns OFF, and when the LED current flowing to the resistor R24 increases beyond the target value, the shunt regulator IC1432 turns ON.

When the shunt regulator IC1432 turns ON, a current flows from the point A to the ground through the resistor R11, a light emitting diode (a light emitting element) of the photocoupler PC1, and the shunt regulator IC1432, whereby a current is generated in a photo-transistor (a light receiving element) of the photocoupler PC1. In this embodiment, this current constitutes a feedback signal, and the feedback signal is input into the switch circuit 61. When the shunt regulator IC1432 turns OFF, on the other hand, a current does not flow to the photo-transistor (the light receiving element), and therefore the feedback signal is not input into the switch circuit 61.

When a current is generated in the photo-transistor (the light receiving element) of the photocoupler PC1, a transistor Q2 of the switch circuit 61 turns ON such that a gate voltage of a FET (Field Effect Transistor) Q1 is reduced (drawn into the ground). As a result, the switching control of the switch circuit 61 is stopped, leading to a reduction in the output of the switching transformer. When a current is not generated in the photo-transistor (the light receiving element) of the photocoupler PC1, on the other hand, the transistor Q2 of the switch circuit 61 turns OFF, whereby a voltage corresponding to a voltage generated in a feedback winding of the switching transformer is applied to a gate of the FET Q1. When the voltage generated in the feedback winding exceeds a certain fixed value (an ON voltage of the FET Q1), the transistor Q2 turns ON, and when the voltage generated in the feedback winding is smaller than the certain fixed value, the transistor Q2 turns OFF.

In other words, the feedback circuit 54 and the switch circuit 61 exhibit the following actions. If the voltage actually generated in the resistor R24 is smaller than a voltage generated in the resistor R24 when the LED current is at the target value, the shunt regulator IC1432 turns OFF. As a result, a current does not flow to the photo-transistor of the photocoupler PC1, and the switch circuit 61 applies the power supply voltage to the switching transformer in a predetermined period. If, on the other hand, the voltage actually generated in the resistor R24 is larger than the voltage generated in the resistor R24 when the LED current is at the target value, the shunt regulator IC1432 turns ON. As a result, a current flows to the photo-transistor of the photocoupler PC1, and the switch circuit 61 reduces the period in which the power supply voltage is applied to the switching transformer below the predetermined period (stops power supply voltage application).

As described above, with the LED lighting circuit 50 according to this embodiment, the circuit configuration of the LED lighting circuit can be simplified, and the LED current can be kept constant while reducing the cost of the LED lighting circuit.

Note that, this invention is not limited to the above-mentioned embodiments. Although it is to those skilled in the art, the following are disclosed as the one embodiment of this invention.
Mutually substitutable members, configurations, etc. disclosed in the embodiment can be used with their combination altered appropriately.
Although not disclosed in the embodiment, members, configurations, etc. that belong to the known technology and can be substituted with the members, the configurations, etc. disclosed in the embodiment can be appropriately substituted or are used by altering their combination.
Although not disclosed in the embodiment, members, configurations, etc. that those skilled in the art can consider as substitutions of the members, the configurations, etc. disclosed in the embodiment are substituted with the above mentioned appropriately or are used by altering its combination.

Although the invention has been described in considerable detail in language specific to structural features and or method acts, it is to be understood that the invention defined in the appended claims is not necessarily limited to the specific features or acts described. Rather, the specific features and acts are disclosed as preferred forms of implementing the claimed invention. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, proximal, distal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

What is claimed is:

1. An LED lighting circuit that generates a power supply voltage required to light a light emitting diode (LED) by boosting a power supply voltage, comprising
a power supply circuit that is formed integrally with the LED lighting circuit and supplies the power supply voltage, and
a feedback circuit that detects an LED current flowing to the LED and feeds the LED current back to the power supply circuit; and
the power supply circuit controls the power supply voltage supplied to the LED lighting circuit so that the LED current converges on a target value.

2. The LED lighting circuit according to claim 1, wherein the power supply circuit is a switching power supply circuit,
the feedback circuit feeds the LED current back to a primary side of the switching power supply circuit, and
the power supply circuit includes a switch circuit that controls a period in which the power supply voltage is applied to a primary winding of a switching transformer of the switching power supply circuit so that the LED current converges on the target value.

3. The LED lighting circuit according to claim 2, wherein the feedback circuit includes a shunt regulator and generates a feedback signal when the shunt regulator turns ON such that a current flows from a cathode to an anode of the shunt regulator,
when the LED current is smaller than the target value, the shunt regulator turns OFF such that the feedback signal is not input into the switch circuit, and when the feedback signal is not input, the switch circuit applies the power supply voltage to the switching transformer in a predetermined period, and
when the LED current is larger than the target value, the shunt regulator turns ON such that the feedback signal is input into the switch circuit, and when the feedback signal is input, the switch circuit reduces the period of the power supply voltage applied to the switching transformer below the predetermined period.

4. The LED lighting circuit according to claim 3, wherein the feedback circuit includes a resistor disposed between a cathode of the LED and a ground,
the LED current flows to the resistor,
a voltage generated in the resistor is input into a reference terminal of the shunt regulator,
the shunt regulator turns OFF if the voltage generated in the resistor is smaller than a voltage generated in the resistor when the LED current is at the target value, and
the shunt regulator turns ON if the voltage generated in the resistor is larger than the voltage generated in the resistor when the LED current is at the target value.

5. The LED lighting circuit according to claim 1, wherein the switching power supply circuit is a self-excited oscillation type switching power supply circuit,
the feedback circuit feeds the LED current back to a primary side of the switching power supply circuit,
the power supply circuit includes a switch circuit that controls a period in which the power supply voltage is applied to a primary winding of a switching transformer of the switching power supply circuit so that the LED current converges on a target value,
the feedback circuit includes a shunt regulator, a resistor disposed between a cathode of the LED and a ground, and a photocoupler, such that when an LED side terminal voltage of the resistor is input into a reference terminal of the shunt regulator and a current flows from a cathode to an anode of the shunt regulator, a light emitting element of the photocoupler is lit such that a current flows to a light receiving element of the photocoupler,
if the voltage generated in the resistor is smaller than a voltage generated in the resistor when the LED current is at the target value, the shunt regulator turns OFF such that a current does not flow to the light receiving element of the photocoupler, and when a current does not flow to the light receiving element of the photocoupler, the switch circuit applies the power supply voltage to the switching transformer in a predetermined period, and
if the voltage generated in the resistor is larger than the voltage generated in the resistor when the LED current is at the target value, the shunt regulator turns ON such that a current flows to the light receiving element of the photocoupler, and when a current flows to the light receiving element of the photocoupler, the switch circuit reduces a period in which the power supply voltage is applied to the switching transformer below the predetermined period.

6. A liquid crystal display device that uses the LED lighting circuit according to claim 1 as a light source of a liquid crystal panel.
